(19) United States
(12) Patent Application Publication
(10) Pub. No.: US 2022/0074059 A1
(43) Pub. Date: Mar. 10, 2022

(54) ELECTROLYTIC CELL FOR H2 GENERATION

(71) Applicant: Battolyser Holding B.V., Schledam (NL)

(72) Inventors: Bernhard Weninger, Delft (NL); Fokko Marten MULDER, Delft (NL)

(73) Assignee: Battolyser Holding B.V., Schledam (NL)

(21) Appl. No.: 17/417,736

(22) PCT Filed: Dec. 31, 2019
(86) PCT No.: PCT/NL2019/050881

§ 371 Date: Jun. 23, 2021

(30) Foreign Application Priority Data
Dec. 31, 2018 (NL) 2022332

(51) Int. Cl. C25B 9/65; C25B 1/04; C25B 9/19; C25B 15/02; C25B 11/042; C25B 11/032

(52) U.S. Cl. CPC C25B 9/65; C25B 1/04; C25B 11/032; C25B 15/02; C25B 11/042; C25B 9/19

(57) ABSTRACT

The invention provides an electrolytic cell (200) for temporally shifted electrolytic production of H₂ and O₂, the electrolytic cell comprising a cell compartment (210), wherein the cell compartment comprises a gas evolution electrode (220) and an electron storage electrode (230), wherein the gas evolution electrode comprises a nickel-based electrode, wherein the electron storage electrode comprises an iron-based electrode, and wherein an electrochemical storage capacity C_{gee} of the gas evolution electrode is≤5% of an electrochemical storage capacity C_{esc} of the electron storage electrode.

### FIELD OF THE INVENTION

The invention relates to an electrolytic cell for temporally shifted electrolytic production of H₂ and O₂. The invention further relates to a method for controlling the electrolytic cell. The invention further relates to an electrolytic system comprising the electrolytic cell. The invention further relates to a use of the electrolytic cell.

### BACKGROUND OF THE INVENTION

Electrolysers for H₂ production are known in the art. US2016362799, for instance, describes a system for producing hydrogen, oxygen and electrical energy from renewable energy and a mixture of sea water which, once desalinated, is mixed with different chemical components. In particular, it relates to a system for producing hydrogen and oxygen and electrical energy, based on harvesting renewable energy that is conveyed to a desalination means and electrolysers which produce hydrogen and oxygen in such a way that the product is directed to compressors which in turn direct the product to receptacles that can withstand the pressure at which said product is stored for the distribution and sale thereof. Alternatively, the hydrogen is conveyed to a fuel cell to be transformed into electrical energy, and converted, using an inverter, into alternating current to be delivered to an electrical grid. In this way, when for any reason the hydrogen and the oxygen produced cannot be stored, they can be directed to the fuel cell which transforms the excess portion from the production of hydrogen into electrical energy.

WO2015056641A1 describes a water electrolysis device and an energy storage and supply system in which the water electrolysis device is used. The water electrolysis device for electrolyzing water and generating hydrogen and oxygen is provided with: an aqueous electrolyte solution containing an intermediate product which repeatedly undergoes oxidation-reduction reactions; an electrolytic electrode for electrolyzing water; an intermediate electrode for performing the oxidation-reduction reactions of the intermediate product; and an electrolytic tank for housing the aqueous electrolyte solution, the electrolytic electrode, and the intermediate electrode; the intermediate product having an oxidation reduction potential higher than the hydrogen generation potentials of the intermediate electrode and the intermediate product and lower than the hydrogen generation potential of the electrolytic electrode.

WO2009127145A1 describes an electrochemical system comprising Zn and H₂O for producing and storing hydrogen, in which an electrode obtained by electrodepositing Zn on the current collector is used as a current collector of Zn electrode. The current collector of Zn electrode and a gas-releasing electrode is separately arranged in a zinc compound-containing aqueous electrolyte, thus a unit of electrochemical system for producing and storing hydrogen can be constructed. The unit of electrochemical system for producing and storing hydrogen can be arranged in a sealed container in which a liquid input passage, a liquid output passage and a passage for holding electrode can be reserved. In the system, the liquid input passage and the liquid output passage are connected with a bump and the electrolyte container, in which a water replenishing passage is arranged and a gas-liquid separator is connected. Wherein, the range of the distance between the said current collector of Zn electrode and the gas-releasing electrode is 1 mm-30 mm.

US2008190781A1 describes an electrochemical method for producing and storing hydrogen, which is a closed system consisting of a gas-generating electrode, an electrolyte and a zinc electrode, the gas-generating electrode and zinc electrode are connected respectively to the external circuits; wherein switching on the external circuit of the gas-generating electrode and zinc electrode the hydrogen is to be released, the reduction reaction of water occurs on the gas-generating electrode producing hydrogen; zinc is oxidized on the zinc electrode generating the oxidation products of zinc; when the hydrogen is to be stored, supplementary water is supplied to the closed system, the negative pole of power source is connected to the external circuit of the zinc electrode, and the positive pole of power source is connected to the external circuit of the gas-generating electrode, switching on the direct current, the reduction reaction of zinc occurs on the zinc electrode, the oxidation products of zinc are reduced into zinc, renew the zinc electrode, the oxidation reaction of water occurs on the gas-generating electrode, the oxygen is generated and discharged.

### SUMMARY OF THE INVENTION

About 1% of the world energy demand may be related to dihydrogen (H₂) production, which may currently largely be based on fossil fuels. As it may be desirable to forgo the use of fossil fuels in the ongoing energy transition, it may further be desirable to improve fossil fuel independent H₂ production.

Electrolysers may provide an alternative to the fossil fuel based H₂ production via energy-driven decomposition of water (H₂O) into dioxygen (O₂) and H₂. In particular, electrolysers may be operated using energy from renewable electricity sources to provide H₂. Thereby, electrolysers may provide H₂ production with a minimal carbon footprint. The electrolysers described in the prior art may, however, provide H₂ only while the electrolysers are provided with energy. Thereby, the H₂ production of these electrolysers may be dependent on the natural fluctuations of (variable) renewable energy sources, such as due to continuous fluctuations in wind strength and cloud coverage, as well as due to diurnal and/or seasonal fluctuations. In contrast, the efficient operation of H₂-dependent industrial processes may benefit from, or even require, a continuous H₂ supply.

Hence, at moments wherein no energy from renewable electricity sources is available, the H₂ may currently need to be provided via (i) (electrolysers operated using) energy from non-renewable sources, (ii) electrolysers operated using energy from stored renewable energy (such as battery backup capacity), which may result in an energy efficiency loss, or (iii) pre-generated and stored H₂. Here, the present invention provides the advantage that with a given storage capacity for renewable electricity about 7 times more H₂ can be generated than with the process according to (ii).

Further, electrolysers described in the art may be expensive due to one or more of (i) expensive electrode materials, (ii) the (large) number of electrodes, and/or (iii) one or more membranes configured between electrodes to prevent O₂ and H₂ from mixing, which mixture may provide an explosion risk. Further, operation with a membrane may result in (additional) ohmic losses, and may decrease the system (energy) efficiency.

Further, electrolysers or integrated battery-electrolysers (sometimes referred to as “battolysers”) with integrated hydrogen storage described in the prior art may not be easily scale-able to larger bipolar configurations as each cell within the array may require an additional electronic circuit. Bipolar operation may allow for a reduction of control equipment and hence for reduced costs.

Hence, it is an aspect of the invention to provide an alternative electrolytic cell, which preferably further at least partly obviates one or more of above-described drawbacks. The present invention may have as object to overcome or ameliorate at least one of the disadvantages of the prior art, or to provide a useful alternative.

Therefore, in a first aspect, the invention provides an electrolytic cell for (temporally shifted) electrolytic production of H₂ and O₂. The electrolytic cell may comprise a cell compartment. The cell compartment may comprise a gas evolution electrode and an electron storage electrode, especially in embodiments the gas evolution electrode may be in fluid contact with the electron storage electrode via an electrolyte. In embodiments, the gas evolution electrode may comprise one or more of nickel, platinum, stainless steel, and titanium, especially the gas evolution electrode at least comprises nickel. Especially, the gas evolution electrode may comprise an electrode selected from the group consisting of a nickel-based electrode, a stainless steel-based electrode, a titanium-based electrode and a platinum-based electrode. In further embodiments, the electron storage electrode may comprise one or more of iron, zinc and cadmium, especially the electron storage electrode at least comprises iron. Especially, the electron storage electrode may comprise an electrode selected from the group consisting of an iron-based electrode, a zinc-based electrode and a cadmium-based electrode, especially from the group consisting of an iron-based electrode and a zinc-based electrode (these may be more preferable in view of environmental considerations). In further embodiments, an electrochemical storage capacity C_{gee} (in ampere hour; Ah) of the gas evolution electrode may be≤5%, especially ≤1%, of an electrochemical storage capacity Cₑₛₑ (in ampere hour) of the electron storage electrode.

The electrolytic cell according to the invention may be configured to decompose H₂O to O₂ and H₂, while the production of O₂ and H₂ may be temporally shifted. In particular, in embodiments, the electrolytic cell may provide substantially pure O₂ at the gas evolution electrode during a charging operation, whereas the electrolytic cell may provide substantially pure H₂ at the gas evolution electrode during a discharging operation. Hence, the electrolytic cell may be configured to provide (renewable) H₂ during moments where no renewable energy sources are available.

The electrolytic cell may especially be configured to operate using solid electrodes that have a low solubility in the operation conditions, such as an iron-based electrode in an alkaline electrolyte. In particular, the electron storage electrode may be solid in both the charged and discharged state. Further, the active electrode material of the electron storage electrode may remain within the (porous) body of electron storage electrode (during operation of the electrolytic cell).

The electrolytic cell may especially an alkaline electrolytic cell, i.e., the electrolytic cell may especially be configured to operate in alkaline conditions.

The term “alkaline” may herein especially refer to a pH≥7, especially ≥8, such as a pH selected from the range of 8-16, such as ≥9, especially ≥10, such as ≥11, especially ≥12, such as ≥13. Hence, in embodiments, alkaline may especially refer to a pH ≥12, such as a pH selected from the range of 12-16.

In embodiments, the electrolytic cell according to the invention may be devoid of gas separation membranes, i.e. in embodiments the cell compartment may be a membraneless compartment.

In further embodiments, the electrolytic cell may comprise a (nickel-based) gas evolution electrode with a low electrochemical storage capacity, especially with approximately no capacity in practical circumstances. The electrolytic cell according to the invention may provide faster (onset of) H₂ production relative to prior art systems, since the electrochemical storage capacity does not need to be depleted first.

In embodiments, the electrolytic cell may comprise a single gas evolution electrode facilitating both oxygen evolution and hydrogen evolution, dependent on the direction of the current flow. Oxygen evolution and hydrogen evolution may be time shifted, especially time separated. Therefore, gas separation by means of a membrane may not be necessary, though this may (partially) depend on the desired purity requirement.

In further embodiments, the electrolytic cell comprises two electrodes, a single electrode for electron storage and a single electrode for gas evolution.

The electrolytic cell according to the invention may provide renewable H₂, especially to industrial sites, at times when no renewable electricity is available. Most of the energy which is required for H₂ generation may be stored inside the cell at times when (renewable) electricity is abundant. Releasing the H₂ later may require a substantially reduced potential, for example about 0.25V (absolute value), compared to for electrolysis operation, which may be about 1.75V (absolute value). Hence, the electron storage electrodes may be charged when (renewable) electricity is abundant and H₂ may be released when (renewable) electricity is scarce. Hence, the electrolytic cell according to the invention decouples (in time) the electricity input from the hydrogen output.

The term “renewable H₂” may be used herein to refer to H₂ that is generated from energy from renewable energy sources. Renewable energy sources are known to the person skilled in the art and may include, solar, wind, ocean, hydropower, biomass, geothermal resources, and other energy sources, such as biofuels, obtained from aforementioned renewable energy sources.

In embodiments, the rate for H₂ production may be controllable by controlling the potential difference between the electron storage electrode and the gas evolution electrode.

An electrolytic cell (also: “cell”) is a type of electrochemical cell. In particular, an electrolytic cell is an electrochemical cell capable of driving a (non-spontaneous) redox reaction through the application of electrical energy (also: “electrical power”). In general, electrolytic cells may be used to decompose (also: “electrolyse”) chemical compounds.

The term “temporally shifted” herein as in “temporally shifted electrolytic production of H₂ and O₂” may refer to two or more events (primarily) occurring at different points in time, especially being (substantially) non-overlapping in time. For example, occurrences of two temporally shifted events over time may resemble a bimodal distribution. For example, the electrolytic cell may facilitate temporally shifting the supply of electrical energy to the electrolytic cell and the production of H₂, i.e., first the electrolytic cell may be charged with the electrical energy, and at a later moment in time the electrolytic cell may provide H₂. Similarly, the electrolytic cell may provide (substantially pure) O₂ during charging of the electrolytic cell, and may provide (substantially pure) H₂ during discharging of the electrolytic cell. Hence, the O₂ production and the H₂ production may be substantially temporally shifted. It will be clear to the person skilled in the art, however, that some basal level of H₂ may be provided during the charging of the electrolytic cell, i.e., the H₂ and O₂ production may be partially overlapping in time. However, the term temporally shifted” may especially imply that during a time period essentially only H₂ may be produced, while O₂ is essentially not produced.

The electrolytic cell may comprise a cell compartment. The cell compartment may comprise a gas evolution electrode and an electron storage electrode. The cell compartment may further comprise a cell compartment opening configured for adding a fluid, such as an electrolyte, to the cell compartment and/or for removing a fluid, such as the electrolyte or produced H₂ or O₂, from the cell compartment. Hence, in embodiments, the cell compartment may be configured for hosting an electrolyte, especially the cell compartment may comprise an electrolyte (during operation).

The term “cell compartment opening” may also refer to a plurality of different cell compartment openings. In embodiments, the plurality of cell compartment openings may especially be configured for adding and/or removing different fluids. In further embodiments, the plurality of cell compartment openings may facilitate purging the gas from the electrolytic cell, especially by flushing the electrolytic cell with an inert gas, such as with N₂. Purging may, for example, be beneficial if a quick transition between charging and discharging is required to limit the mixing of O₂ and H₂.

During operation (of the electrolytic cell), the cell compartment may further comprise a (liquid) electrolyte. The (liquid) electrolyte may be in (liquid) contact with both the gas evolution electrode and the electron storage electrode.

In embodiments, the electrolytic cell may comprise an airtight housing (also “gastight housing”) comprising the cell compartment. The airtight housing may be substantially closed, except for aforementioned cell compartment opening. Especially during operation of the electrolyte cell, the housing may be airtight. This allows control of the pressure (see also below).

The gas evolution electrode may be configured to evolve gases during both charging and discharging of the electrolytic cell, especially to provide O₂ during charging and H₂ during discharging. Hence, in embodiments, the gas evolution electrode may be configured for electron transfer rather than for electron storage, i.e., the gas evolution electrode may have a low electrochemical storage capacity C_{gee}, such as an electrochemical storage capacity C_{gee}≤10 Ah/cm³ (with respect to bulk volume), such as ≤1 Ah/cm³ (bulk volume), especially ≤0.5 Ah/cm³ (bulk volume), especially ≤0.1 Ah/cm³ (bulk volume), such as ≤10 mAh/cm³ (bulk volume), such as ≤1 mAh/cm³ (bulk volume), including 0 mAh/cm³ (bulk volume). The low electrochemical storage capacity C_{gee} may facilitate a minimal delay between starting to discharge the electrolytic cell and the electrolytic cell providing H₂. In further embodiments, the gas evolution electrode may have an electrochemical storage capacity C_{gee} of approximately 0 mAh. In further embodiments, the gas evolution electrode may have an electrochemical storage capacity C_{gee}≥0 mAh/cm³ (bulk volume), such as ≥1 mAh/cm³ (bulk volume).

In embodiments, the gas evolution electrode may be configured to be a stable electrode, i.e., the gas evolution electrode may be configured to be chemically stable during the operation of the device; the electrode material does not directly react. For example, in embodiments wherein the gas evolution electrode comprises a nickel-based electrode, the gas evolution electrode may be configured to essentially comprise at its outermost surface layer NiOOH during oxygen evolution and Ni during hydrogen evolution.

In embodiments, the gas evolution electrode may be a porous electrode. A porous gas evolution electrode may be beneficial as a porous electrode may have a reduced volume for a given surface area, especially, in further embodiments, a lower electrochemical storage capacity for a given surface area. A porous electrode may further be beneficial as less material may be required to obtain a desired surface area, which may reduce material costs. A large surface area may be beneficial for evolution of O₂ and/or H₂.

The electron storage electrode may be configured to store electrons during charging of the electrolytic cell and to provide electrons during discharging of the electrolytic cell. In embodiments, the electron storage electrode may have an electron storage capacity Cₑₛₑ≥0.01 Ah/cm³ (with respect to bulk volume), such as ≥0.1 Ah/cm³ (bulk volume), especially ≥0.5 Ah/cm³ (bulk volume).

In further embodiments, the electron storage electrode may have an electrochemical storage capacity Cₑₛₑ≤1000 Ah/cm³ (bulk volume), such as ≤100 Ah/cm³ (bulk volume).

The term “Electrochemical storage capacity” refers to the capacity of an electrode expressed in ampere-hour (Ah). The electrochemical storage capacity of an electrode may be determined by first charging and then discharging the electron storage electrode at low rates. The discharge capacity is the amount of charge retrieved from the charged electrode at a slow discharge rate up to the cut-off voltage and defines the storage capacity. For example, the discharge capacity may be the amount of charge retrieved from the charged electrode when discharged at a constant current with a discharge time of at least 10 hours at a specific cut-off voltage. The cut-off voltage may be selected based on the electrode material (and depending on pH), for example: (i) for an iron-based electrode: −750 mV (the potential of an iron based electron storage electrode (negative electrode) vs a mercury/mercury oxide (Hg/HgO) reference electrode (positive electrode), (ii) for a cadmium-based electrode: −600 mV (the potential of a cadmium based electron storage electrode (negative electrode) vs a mercury/mercury oxide (Hg/HgO) reference electrode (positive electrode)), (iii) for a zinc-based electrode: −1000 mV (the potential of a zinc based electron storage electrode (negative electrode) vs a mercury/mercury oxide (Hg/HgO) reference electrode (positive electrode). The person skilled in the art will be able to select appropriate cut-off voltages for (other) electrode materials and for specific pH values.

In embodiments, the electron storage electrode may be a solid electrode. In further embodiments, the gas evolution electrode may be a solid electrode. The term “solid” with regards to an electrode may herein refer to the electrode being in a solid phase in the charged state and in the discharged state, especially in an alkaline solution. In particular, a solid electrode may essentially be insoluble in the electrolyte, especially in the alkaline electrolyte.

In further embodiments, the electrode storage electrode may have a solubility (in the electrolyte at room temperature) of≤100 mM/L, such as ≤10 mM/L, especially ≤5 mM/L, such as ≤1 mM/L, especially ≤100 μM/L. An iron-based electrode may, for example, be a solid electrode, especially when operated in alkaline conditions. In further embodiments, the electron storage electrode may have a solubility≥1 pM/L, especially ≥1 nM/L such as ≥1 μM/L.

In further embodiments, the electron storage electrode comprises a solid iron-based electrode, especially an (in alkaline conditions) insoluble iron-based electrode.

During operation of the electrolytic cell, the cell compartment may comprise an electrolyte in fluid contact with the gas evolution electrode and the electron storage electrode. An electrolyte is an electrically conductive medium wherein the flow of electric current is tied to the movement of ions. In embodiments, the electrolyte may be a liquid electrolyte, especially an aqueous electrolyte comprising one or more of KOH, NaOH, LiOH and Ba(OH)₂. Especially, the concentration of hydroxide (OH⁻) in water may be selected from the range of 0.1-8 mol/L, especially from the range of 1.0-7 mol/L, such as from the range of 4-6.5 mol/L.

Hence, in embodiments, the electrolyte may be an alkaline electrolyte, especially the electrolyte may have a pH selected from the range 12-16, especially from the range of 13-15. In further embodiments, the electrolyte may comprise a concentration of hydroxide (OH⁻) selected from the range of 0.1-8 mol/L, especially from the range of 1.0-7 mol/L, such as from the range of 4-6.5 mol/L.

In further embodiments, the electrolytic cell may be configured to operate with an alkaline electrolyte, especially with an electrolyte with a pH selected from the range 12-16, especially from the range of 13-15.

The term “membrane” herein refers to a selective barrier. For example, a membrane may allow H₂O to pass through while preventing H₂ and/or O₂ from passing through. Similarly, a membrane may allow some ions to pass through while preventing other ions from passing through.

The term “bulk volume” herein refers to the volume of a solid added to the volume of any sealed and/or open pores present in the solid. Hence, for a solid electrode, the bulk volume may be approximately equal to the volume of the electrode, while the bulk volume of a porous electrode may be (substantially) larger than the volume of the solid (porous) electrode.

In embodiments and during operation, the electrolytic cell may provide a charging gas while charging, and the electrolytic cell may provide a discharging gas while discharging. The charging gas may essentially comprise O₂, such as have an O₂ concentration ≥80 vol. %, especially ≥90 vol. %, such as ≥95 vol. %, especially ≥97 vol. %, such as ≥99 vol. % including 100 vol. %. The discharging gas may essentially comprise H₂, such as have an H₂ concentration≥80 vol. %, such as ≥90 vol. %, especially ≥95 vol. %, such as ≥99 vol. % including 100 vol. %. In further embodiments, and during operation, the charging gas may comprise (some) H₂ and/or an inert gas, especially an inert gas, and/or the discharging gas may comprise (some) O₂, and/or an inert gas, especially an inert gas.

In embodiments, the electrochemical storage capacity C_{gee} of the gas evolution electrode may be≤5% of the electrochemical storage capacity Cₑₛₑ of the electron storage electrode, such as ≤3%, especially ≤1%, such as ≤0.5%, especially ≤0.1%, such as ≤0.01%. Hence, in embodiments, the gas evolution electrode has an electrochemical storage capacity C_{gee} dependent on the (active) mass of gas evolution electrode material, especially nickel, and the electron storage electrode has an electrochemical storage capacity Cₑₛₑ dependent on the (active) mass of electron storage electrode material, especially iron, and the electrochemical storage capacity C_{gee} of the gas evolution electrode may be≤5% of the electrochemical storage capacity Cₑₛₑ of the electron storage electrode.

In further embodiments, the electrochemical storage capacity C_{gee} of the gas evolution electrode may be≥0.0001% of the electrochemical storage capacity Cₑₛₑ of the electron storage electrode, such as ≥0.001%, especially ≥0.01%, such as ≥0.1%.

However, despite the substantially reduced electrochemical storage capacity of the gas evolution electrode with respect to the electron storage electrode, the (total) surface area of the gas evolution electrode may be similar to the (total) surface area of the electron storage electrode. The term “surface area” herein especially refers to a geometric surface area of an electrode. Especially, the geometric surface area of an electrode facing another electrode. Hence, a phrase such as “the surface area of the gas evolution electrode≥10% of the surface area of the electron storage electrode” may indicate that the surface area of the side of the gas evolution electrode facing the electron storage electrode≥10% of the surface area of the side of the electron storage electrode facing the gas evolution electrode.

The term “total surface area” herein refers to the surface area of the electrode including the surface area of any (open) pores.

In embodiments, the (total) surface area of the gas evolution electrode≥10% of the (total) surface area of the electron storage electrode, especially ≥20%, such as ≥35%, especially ≥50% such as ≥75%, especially ≥90%, including 100%. In further embodiments, the (total) surface area of the gas evolution electrode may be≤500% of the (total) surface area of the electron storage electrode, especially ≤400%, such as ≤300%, especially ≤200%, such as ≤150%, especially ≤125%, such as ≤100%, especially ≤90%, such as ≤80%.

In embodiments, the cell compartment may comprise a cell compartment opening configured for adding a fluid, such as an electrolyte, to the cell compartment and/or for removing a fluid, such as the electrolyte or produced H₂ or O₂, from the cell compartment. In further embodiments, the same cell compartment opening may be configured for providing H₂ and O₂ (at different moments in time), particularly from the cell compartment.

In further embodiments, the cell compartment opening may comprise a valve configured to control the passage of fluid in the cell compartment opening. Hence, during operation, in embodiments, the valve may be configured to be in a first valve position while the electrolytic cell is charging and in a second valve position while the electrolytic cell is discharging, such that the charging gas, especially O₂, and the discharging gas, especially H₂, may be provided separately. For example, such that the charging gas and the discharging gas may be provided to separate storage systems or to separate units of a storage system.

In embodiments, the electrolytic cell may comprise an airtight housing comprising the cell compartment. The airtight housing may be substantially closed, except for aforementioned cell compartment opening, i.e. the airtight housing may comprise an airtight housing opening arranged at the cell compartment opening.

For electrical connection, the electrodes may be connected with an electrical connection which is also accessible from external from the electrolytic cell, especially from external from the airtight housing. Hence, the electrolytic cell may further comprise a first electrical connection in electrical connection with the gas evolution electrode, and a second electrical connection in electrical connection with the electron storage electrode.

In embodiments, the cell compartment may be a membrane-free compartment. Hydrogen production and oxygen production may be temporally shifted, hence, in embodiments, the electrolytic cell may be safely operated without membrane. This may allow for new geometric configurations of the cell compartment, especially of the electrodes, to minimize transport limitations and optimize the geometry (without membrane-limitations) between the electrodes.

In further embodiments, the gas evolution electrode and the electron storage electrode may be interdigitated. It will be clear to the person skilled in the art that the interdigitated gas evolution electrode and the electron storage electrode will be arranged at a distance, i.e., they do not touch, to prevent short-circuiting.

The invention may herein, for explanatory purposes, primarily be described with respect to an electrolytic cell comprising a gas evolution electrode comprising nickel and an electron storage electrode comprising iron. The invention is, however, not limited to such embodiments and both the gas evolution electrode and the electron storage electrode may comprise different materials. “It will be clear to the person skilled in the art that the selected electrode material may affect operational parameters of the electrolytic cell, such as different ranges of potential difference and/or current flow resulting in charging and/or discharging. The person skilled in the art will be able to select appropriate values based on the electrode materials and the invention as described herein, i.e., the person skilled in the art will select suitable operational parameters to provide O₂ evolution at the gas evolution electrode during a charging operation, and to provide H₂ evolution at the gas evolution electrode during a discharging operation.

In embodiments, the gas evolution electrode may comprise one or more of Ni, Fe, Ru, Ir, P, Sn, W, Mo, Zn, Co, Pt, Ti, SST (stainless steel; also: “RVS” (“roestvrij staal”), and Cr, especially one or more of Ni, Pt, Fe, Ti, SST, Sn and P, more especially one or more of Ni, Pt, Ti, and SST.

In further embodiments, the gas evolution electrode may comprise an electrode selected from the group consisting of a nickel-based electrode, a stainless steel-based electrode (that is: an electrode based on stainless steel, also: “SST-based electrode”), a titanium-based electrode, and a platinum-based electrode.

In further embodiments, the gas evolution electrode may comprise a nickel-based electrode. During operation, the (nickel-based) gas evolution electrode may essentially go through Ni(OH)₂→NiOOH→Ni(OH)₂→Ni→Ni(OH)₂ cycles, i.e., the (nickel-based) gas evolution electrode may comprise essentially NiOOH during oxygen production (charging of the electrolytic cell), and may comprise essentially Ni during hydrogen production (discharging of the electrolytic cell). In further embodiments, the nickel-based gas evolution electrode may further comprise one or more of Fe, Ru, Ir, P, Sn, W, Mo, Zn, Co, Pt, Ti, SST, and/or Cr.

In further embodiments, the gas evolution electrode may comprise a platinum-based electrode. During operation, the (platinum-based) gas evolution electrode may essentially go through PtO₂→Pt(OH)₂→Pt→Pt(OH)₂→PtO₂ cycles, i.e., the (platinum-based) gas evolution electrode may comprise essentially PtO₂ during oxygen production (charging of the electrolytic cell), and may comprise essentially Pt during hydrogen production (discharging of the electrolytic cell). In further embodiments, the platinum-based gas evolution electrode may further comprise one or more of Ni, Fe, Ru, Ir, P, Sn, W, Mo, Zn, Co, Ti, SST, and Cr.

In further embodiments, the gas evolution electrode may comprise a titanium-based electrode. In further embodiments, the titanium-based gas evolution electrode may further comprise one or more of Ni, Fe, Ru, Ir, P, Sn, W, Mo, Zn, Co, SST, and Cr Ni, Fe, Sn, and P.

In further embodiments, the gas evolution electrode may comprise a stainless steel-based electrode. In further embodiments, the stainless steel-based gas evolution electrode may further comprise one or more of Ni, Fe, Ru, Ir, P, Sn, W, Mo, Zn, Co, Ti, and Cr.

In further embodiments, the gas evolution electrode may comprise an alloy. Especially, the gas evolution electrode may comprise an alloy comprising nickel and/or iron, such as nickel and iron, more especially a Ni—Fe alloy.

In embodiments, the electron storage electrode may comprise one or more of Fe, Zn and Cd.

In further embodiments, the electron storage electrode may comprise an electrode selected from the group consisting of an iron-based electrode, a zinc-based electrode and a cadmium-based electrode.

In embodiments, the electron storage electrode may comprise an iron-based electrode. During operation, the (iron-based) electron storage electrode may essentially go through Fe→Fe(OH)₂→Fe cycles, i.e., the (iron-based) electron storage electrode may in a charged state essentially comprise Fe (metal) and in a discharged state comprise essentially Fe(OH)₂. In particular, the iron-based electron storage electrode may go through iron reduction and oxidation cycles of the form Fe→Fe(OH)₂→Fe. As will be clear to one skilled in the art, an iron-based electron storage electrode may comprise some Fe(OH)₂ in a charged state and some Fe in a discharged state. Especially, however, the iron-based electron storage electrode may comprise more Fe in the charged state than in the discharged state, and may comprise more Fe(OH)₂ in the discharged state than in the charged state. In further embodiments, the iron-based electron storage electrode may further comprise one or more of Zn and Cd.

In further embodiments, the electron storage electrode may comprise a zinc-based electrode. In further embodiments, the zinc-based electron storage electrode may further comprise one or more of Fe, and Cd.

In further embodiments, the electron storage electrode may comprise a cadmium-based electrode. In further embodiments, the cadmium-based electron storage electrode may further comprise one or more of Fe and Zn.

In further embodiments, the electron storage electrode may comprise an alloy.

The term “-based electrode” such as in “iron-based electrode” herein especially refers to the electrode essentially comprising the mentioned element, such as iron, in the charged state (of the electrode), i.e., the iron-based electrode may essentially comprise Fe in the charged state, but may comprise Fe(OH)₂ in a discharged state. Hence, the term “-based electrode” may refer to the electrode consisting of the mentioned element for at least 50 wt. %, such as at least 60 wt. %, especially 70 at least wt. %, such as at least 80 wt. %, especially at least 90 least wt. %, such as at least 95 least wt. %, especially at least 99 wt. %, including 100 wt. %.

In specific embodiments, the gas evolution electrode may be produced following the procedure for producing a bifunctional porous electrode as described by Yu et al., “High-performance bifunctional porous non-noble metal phosphide catalyst for overall water splitting”, Nature Communications, 2018, which is hereby herein incorporated by reference.

The electron storage electrode may especially be produced as pocket, plastic bound or sintered electrode. In specific embodiments, the electron storage electrode may be produced following the procedure as described in U.S. Pat. No. 4,109,060, which is hereby herein incorporated by reference.

In embodiments, the electron storage electrode may comprise one or more electron storage electrode additives selected from the group comprising bismuth sulfide, bismuth oxide, C, a binder, Ni, Fe, and Ca(OH)₂, Sn, Pb, Cd.

In embodiments, the electrolyte may comprise a liquid electrolyte, especially a water-based electrolyte, comprising one or more of KOH, NaOH, LiOH and Ba(OH)₂.

In embodiments, the size of the gas evolution electrode may be selected from the range of several mm³-several m³. In embodiments, the size of the electron storage electrode may be selected from the range of several mm³-several m³.

In embodiments, the gas evolution electrode may comprise an electrode selected from the group comprising a porous electrode, a mesh electrode, a wire electrode, a (perforated) hollow tube electrode, and a plate electrode, especially an electrode selected from the group comprising a porous electrode, a mesh electrode, a wire electrode, and a plate electrode. In embodiments wherein the gas evolution electrode comprises an electrode selected from the group comprising a mesh electrode, a wire electrode, and a plate electrode, the gas evolution electrode may have a low surface area compared to the electron storage electrode.

In further embodiments, the gas evolution electrode may comprise a porous electrode.

In further embodiments, the gas evolution electrode may comprise a mesh electrode, especially a mesh electrode comprising Ni, SST or Ti, such as a SST mesh electrode. In further embodiments, the gas evolution electrode may comprise a plate electrode. In further embodiments, the gas evolution electrode may comprise a wire electrode. In further embodiments, the gas evolution electrode may comprise a Ti-based carrier. In further embodiments, the gas evolution electrode may comprise a (perforated) hollow tube electrode.

In further embodiments, the gas evolution electrode, especially the mesh electrode, or especially the wire electrode, or especially the perforated hollow tube electrode, may comprise one or more additives selected from the group comprising Fe, Ru, Ir, P, Sn, W, Mo, Zn, Co, Pt, Ti, and/or Cr, especially one or more of Ni, Pt, Fe, Sn and P. These additives may facilitate an improved catalytic activity and, thereby, a reduced energy requirement for O₂ and/or H₂ generation.

In further embodiments, wherein the gas evolution electrode comprises a nickel-based electrode, the gas evolution electrode may comprise a coating comprising NiP and/or NiSn. Especially NiSn. The (NiP and/or NiSn) coating may increase the stability of Ni in an alkaline environment.

In embodiments, the electron storage electrode may be a porous electrode, especially with a porosity selected from the range of 40%-90%, such as from the range of 50%-85%, especially from the range of 60%-80%. The porosity values may refer to the charged state, i.e., the porosity may especially be determined when the electrode is in its charged state.

In embodiments, the gas evolution electrode and the electron storage electrode may be separated by a distance of at least 0.1 mm, such as at least 0.5 mm.

In embodiments, the electrolytic cell may comprise thermal insulation. For example, the electrolytic cell may in embodiments be configured for outside operation, including, in specific embodiments, outside operation during subzero weather conditions and/or, outside operation in high-temperature conditions, such as ≥30° C.

During operation, some H₂ may also evolve at the electron storage electrode, especially during charging. For example, in embodiments wherein the electron storage electrode comprises an iron-based electrode, H₂ evolution may occur when reduced Fe is present via one or more of self-discharge, corrosion, and electrolysis. Hence, some H₂ may be produced during charging and may mix with the produced O₂, which may provide a safety hazard if the H₂ concentration reaches approximately 4%. Hence, in embodiments, one or more safety measures may be taken with respect to the features of the electrolytic cell and/or with regards to the method for controlling the electrolytic cell (see further below).

In embodiments, the cell compartment may further comprise a separator, especially a membrane, arranged between the gas evolution electrode and the electron storage electrode. In embodiments, the separator, especially the membrane, may be non-conductive. In further embodiments, the separator may be configured to prevent short-circuiting of the system. In further embodiments, the separator, especially the membrane, may be configured to block transport of one or more of O₂ and H₂, especially to block transport of H₂, between the gas evolution electrode and the electron storage electrode.

In further embodiments, the separator, especially the membrane, may be arranged to define a gas evolution subcompartment (comprising the gas evolution electrode) and an electron storage subcompartment (comprising the electron storage electrode) (in the cell compartment). In further embodiments, the separator, especially the membrane, may be configured to block transport of one or more of O₂ and H₂ between the gas evolution subcompartment and the electron storage subcompartment. Hence, the gas evolution subcompartment and the electron storage subcompartment may be separated by the membrane. In embodiments, both subcompartments comprise an (liquid) electrolyte, especially the same type of (liquid) electrolyte.

Hence, in embodiments the gas evolution subcompartment comprises an electrolyte and/or in embodiments the electron storage subcompartment comprises an electrolyte (especially the same type of electrolyte).

In further embodiments, wherein the electrolytic cell, especially the cell compartment, comprises a membrane, the membrane may be arranged to define a gas evolution subcompartment (comprising the gas evolution electrode) and an electron storage subcompartment (comprising the electron storage electrode) (in the cell compartment). In further embodiments, the membrane may be configured to block transport of one or more of O₂ and H₂ between the gas evolution subcompartment and the electron storage subcompartment.

In further embodiments, the separator, especially a non-membrane separator, may be arranged (primarily) above the electrolyte, i.e., the lower side of the separator may be arranged at the electrolyte surface, such as above or below the electrolyte surface, especially right below the electrolyte surface, such as ≤10 mm below the electrolyte surface, especially ≤1 mm. In such embodiment, the cell compartment may not be fully separated into subcompartments by the separator, however, for example, the separator may define two (or more) separate gaseous regions in the cell compartment.

In further embodiments, the membrane may be arranged to provide fluid separation between the gas evolution electrode and the electron storage electrode.

In further embodiments, the membrane may be permeable for OH⁻, H₂O. In embodiments, the membrane may be permeable for electrolyte cations, such as one or more of Na⁺, K⁺, Li⁺, and Ba²⁺, such as at least one or more of Na⁺ and K⁺. In embodiments, the membrane may be impermeable for O₂ and H₂.

In further embodiments, the cell compartment, especially the cell compartment opening, may comprise a first cell compartment opening arranged in the gas evolution subcompartment and a second cell compartment opening arranged in the electron storage subcompartment. The first cell compartment opening may be configured for adding a fluid, such as an electrolyte, to the gas evolution subcompartment and/or for removing a fluid, such as the electrolyte or produced H₂ or O₂, from the gas evolution subcompartment. Similarly, the second cell compartment opening may be configured for adding a fluid, such as an electrolyte, to the electron storage subcompartment and/or for removing a fluid, such as the electrolyte or produced H₂, from the electron storage subcompartment. The terms “first cell compartment opening” and “second cell compartment opening” may also refer to a plurality of such openings, such as a plurality of first cell compartment openings.

In embodiments, the electrolytic cell may comprise a recombination catalyst configured to catalyze a recombination of H₂ and O₂ to H₂O. Hence, the recombination catalyst may catalyze the recombination of the H₂ inadvertently evolved at the electron storage electrode during charging with O₂ evolved at the gas evolution electrode to reduce the H₂ concentration, and during switching between charging and discharging, i.e., during switching between the types of gases that evolve). In further embodiments, the recombination catalyst may be selected from the group comprising LaNi₅ and Pt. In further embodiments, the recombination catalyst may be arranged in the cell compartment, especially in a headspace of the cell compartment, such as above the electrolyte level.

In embodiments wherein the electron storage electrode comprises an iron-based electrode, the electron storage electrode may comprise an additive selected from the group comprising bismuth sulfide, bismuth oxide, C, and a binder. Bismuth sulfide and bismuth oxide may facilitate suppressing H₂ formation. Hence, in embodiments, the electron storage electrode may comprise an additive selected from the group comprising bismuth sulfide and bismuth oxide. C may improve the conductivity of the electron storage electrode. The binder, for example PTFE, may facilitate plastic bound electrodes.

In embodiments wherein the electron storage electrode comprises a cadmium-based electrode, the electron storage electrode may comprise an additive selected from the group comprising Ni, Fe, C and a binder. The electron storage electrode may comprise Ni-plated iron as a pocket and/or current collector. PTFE may be a suitable binder for a plastic bound electrode.

In embodiments wherein the electron storage electrode comprises a zinc-based electrode, the electron storage electrode may comprise Ca(OH)₂ as an additive. Ca(OH)₂ may enhance the stability of Zn-based electrode in alkaline solutions.

In further embodiments, the electrolyte may be configured to suppress H₂ formation at the electron storage electrode. Hence, in embodiments, the electrolyte may comprise an electrolyte additive selected from the group comprising Na₂S and K₂S and hydrophobic molecules, especially an electrolyte additive selected from the group comprising hydrophobic molecules.

In specific embodiments, the electrolytic cell may comprise a horizontal bipolar arrangement (of electrodes) or a vertical bipolar arrangement (of electrodes). In further embodiments, the electrolytic cell may comprise a horizontal bipolar arrangement (of electrodes). In further embodiments, the electrolytic cell may comprise a vertical bipolar arrangement (of electrodes).

In a second aspect the invention further provides an electrolytic system comprising the electrolytic cell according to the invention. The electrolytic system, especially the electrolytic cell, may comprise or be functionally coupled to one or more of a fluid control system, a gas storage system, a pressure control system, a charge control unit, a thermal management system (also: “temperature control element”), a hydrogen gas connector, and a control system.

In embodiments, the electrolytic system may comprise a plurality of electrolytic cells. Especially, the electrolytic system may comprise a parallel arrangement and/or a serial arrangement of the plurality of electrolytic cells, especially a parallel arrangement, or especially a serial arrangement. The electrolytic system may simultaneously charge one or more of the plurality of electrolytic cells and discharge one or more of the plurality of electrolytic cells. Thereby, the electrolytic system may continuously provide (renewable) H₂, both when (renewable) energy sources are available and when (renewable) energy sources are not available.

In embodiments, the electrolytic system, especially the electrolytic cell, may comprise or be functionally coupled to a fluid control system configured to control the adding and/or removing of a fluid to the cell compartment, especially the adding/removing of the electrolyte and/or the removing of the charging gas and/or the removing of the discharging gas.

In embodiments, the electrolytic system, especially the electrolytic cell, may comprise or be functionally coupled to a gas storage system configured to store one or more of the charging gas and the discharging gas external from the electrolytic cell. The gas storage system may comprise a storage unit configured to store H₂. The gas storage unit may be configured to store H₂ and/or O₂ under pressure.

In embodiments, the electrolytic system, especially the electrolytic cell, may comprise or be functionally coupled to a pressure control system configured to control the (gas) pressure in the electrolytic cell, and especially also in the gas storage system. In further embodiments the pressure control system may comprise a pressure chamber configured to control a (gas) pressure in the pressure chamber, and the electrolytic system, especially the electrolytic cell, may be arranged in the pressure chamber. In further embodiments, the pressure control system may comprise a vacuum pump. The vacuum pump may be configured to provide an underpressure to remove gasses from the cell compartment, for example when switching between a charging operation and a discharging operation. The vacuum pump may further be configured to reduce the gas pressure in the cell compartment to control, especially reduce, the amount of dissolved gasses in the electrolyte.

In embodiments, the electrolytic system, especially the electrolytic cell, may comprise or be functionally coupled to a charge control unit. The charge control unit may be configured to receive electrical energy from an external electrical energy source and be configured to provide the electrical energy to the electrolytic cell during at least part of a charging time at a current (also: “current strength”) that results in a potential difference between the gas evolution electrode and the electron storage electrode of more than 1.2 V, especially a potential difference≥1.37 V. Hence, during a charging operation, the charge control unit may be configured to impose a potential difference between the gas evolution electrode (then positive electrode or anode) and the electron storage electrode (then negative electrode or cathode) of more than 1.2 V, especially a potential difference≥1.37 V. In further embodiments, during a charging operation, the charge control unit may be configured to impose a potential difference between the gas evolution electrode (then positive electrode or anode) and the electron storage electrode (then negative electrode or cathode) of less than 1.7 V, especially ≤1.5 V, such as ≤1.45, especially during at least part of a charging operation.

For discharging of the electrolytic cell, best results may be obtained when discharging occurs at a potential difference between the electron storage electrode (then positive electrode or anode) and the gas evolution electrode (then negative electrode or cathode) selected from the range 0-1.0 V, such as from the range 0.01-0.3 V. In embodiments, the charge control unit may (also) be configured to control the discharging of the electrolytic cell. Hence, during a discharging operation, the charge control unit may be configured to impose a potential difference between the electron storage electrode and the gas evolution electrode selected from the range 0-1.0 V, such as from the range 0.01-0.3 V.

A phrase such as “to impose a potential difference between a first electrode and a second electrode of more than x V” will be understood by the person skilled in the art to also indicate “to impose a potential difference between a second electrode and a first electrode of less than −x V”. For instance, imposing a potential difference between a first electrode and a second electrode of more than 1.2 V, such as more than 1.37 V, may also imply imposing a potential difference between a second electrode and a first electrode of less than −1.2 V, such as less than −1.37 V.

In embodiments, the electrolytic system, especially the electrolytic cell, may comprise or be functionally coupled to a thermal management system configured to control the temperature of the electrolytic cell equal to or below a predetermined maximum temperature, for instance ≤95° C., especially ≤70° C., such as ≤40° C. In further embodiments, the electrolytic system, especially the electrolytic cell, may comprise or be functionally coupled to a thermal management system configured to control the temperature of the electrolytic cell equal to or above a predetermined minimum temperature, for instance ≥0° C., especially ≥10° C., such as ≥25° C. Hence, the thermal management system may be configured to monitor the temperature of the electrolytic cell, and may further be configured to heat and/or cool the electrolytic cell, especially dependent on the temperature of the electrolytic cell in relation to a target temperature (range). In further embodiments, the thermal management system may be configured to control the heating caused by the electrolytic cell operations by adjusting the potential difference imposed between the electrodes, i.e., if the electrolytic cell is getting too warm, the thermal management system may slow, especially cease, (dis)charging of the electrolytic cell.

In specific embodiments, the thermal management system may be configured to increase the temperature of the electrolytic cell to promote self-discharge of the electron storage electrode. Hence, in embodiments, the electrolytic system, especially the electrolytic cell, may be configured for self-discharging the electron storage electrode by increasing the temperature. Using self-discharge in this manner allows for self-discharge and corresponding H₂ production without a discharge current.

In embodiments, the electrolytic system, especially the electrolytic cell, may comprise or be functionally coupled to a hydrogen gas connector configured for functionally connecting a device to be provided with the charging gas, especially with H₂. The hydrogen gas connector may comprise or be functionally coupled to the cell compartment opening.

In further embodiments, the electrolytic system, especially the electrolytic cell, may comprise a control system configured to control one or more of the fluid control system (if available), the gas storage system (if available), the pressure control system (if available), the charge control unit (if available), the thermal management system (if available), and the hydrogen gas connector (if available). The control system may especially be configured to control the electrolytic system, especially the electrolytic cell, including the individual elements. In this way, the charging and electrolysis process may be optimized, amongst others e.g., dependent upon the availability of (renewable) electrical energy and H₂ demand. Hence, the control system may be configured to control one or more of temperature, fluid flow, and (imposed) potential difference.

In embodiments, the electrolytic system may comprise a plurality of electrolytic cells. In further embodiments, The electrolytic system, especially the control system, may be configured to independently control the plurality of electrolytic cells. For example, the pressure control system may impose different pressures on different electrolytic cells, and the thermal management system may impose different temperatures on different electrolytic cells.

In a further aspect, the invention further provides a method for controlling the electrolytic system, especially the electrolytic cell, according to the invention, the method comprising controlling the potential difference and/or the current flow between the gas evolution electrode and the electron storage electrode. In particular, the method may comprise controlling either the potential difference or the current at a constant value.

Hence, in embodiments, the method may comprise imposing a potential difference between the gas evolution electrode and the electron storage electrode to charge the electrolytic cell (and to provide O₂). In embodiments wherein the electron storage electrode comprises an iron-based electrode or a cadmium-based electrode, the method may especially comprise imposing a potential difference≥1.2 V, especially ≥1.37 V, such as ≥1.4 V. In embodiments wherein the electron storage electrode comprises a zinc-based electrode, the method may especially comprise imposing a potential difference≥1.5 V, such as ≥1.7 V.

Hence, in embodiments, the method may comprise imposing a current flow between the gas evolution electrode and the electron storage electrode to charge the electrolytic cell (and to provide O₂) or to discharge the electrolytic cell to provide H₂. In further embodiments, the method may comprise interrupting, especially stopping, the current flow between the gas evolution electrode and the electron storage electrode.

In further embodiments, the method may comprise imposing a potential difference between the electron storage electrode and the gas evolution electrode to discharge the electrolytic cell (and to provide H₂). In embodiments wherein the electron storage electrode comprises an iron-based electrode or a cadmium-based electrode, the method may especially comprise imposing a potential difference≥0 V, especially ≥0.01 V. In embodiments wherein the electron storage electrode comprises a zinc-based electrode, the method may especially comprise imposing especially a potential difference≥−0.5 V, especially ≥−0.3 V. The negative sign for the zinc-based electrode indicates that an electrolytic cell comprising a zinc-based storage electrode may simultaneously provide electricity and H₂ dependent on the discharging rate (less electricity may be provided if faster H₂ production is desired).

In specific embodiments, the method may comprise imposing an increased temperature selected from the range of 10-100° C., such as from the range of 25-100° C., especially selected from the range of 40-80° C., more especially approximately 60° C., especially such that the electron storage electrode self-discharges and provides H₂. In further specific embodiments, the method may comprise imposing an increased temperature selected from the range of 10-100° C., such as from the range of 10-95° C., especially selected from the range of 20-45° C., especially such that the electron storage electrode self-discharges and provides H₂.

The method according to the invention provides time-shifted charging of the electron storage electrode with energy input and discharging of the electron storage electrode in the form of hydrogen. Hence, in embodiments, at times when there is H₂ production approximately no O₂ is present in the system. The method may thus provide safe operation and high gas quality during H₂ production. During charging, oxygen production is required for charging/regeneration of the electron storage electrode. During charging, the charge rate of the electrolytic system may be kept low to limit H₂ production at the electron storage electrode. Especially, in embodiments, a low charging rate may provide a different ratio of H₂ evolution to O₂ evolution, especially a higher ratio of H₂ evolution to O₂ evolution. For example, time, especially charging time, may be a minor constraint for seasonal storage, hence, in embodiments, slow charging of the electron storage electrode, such as charging at a constant potential and current whereat (full) charging takes≥4 hours, such as ≥10 hours, may be beneficial. Low charging rates may also reduce losses associated with charging, such as ohmic losses in the system and reduced overpotentials for gas production.

In embodiments, the method may comprise monitoring the gas quality during charging. In further embodiments, the method may comprise purging the electrolytic cell with an inert gas, especially N₂, if the gas quality is insufficient, for example if the H₂ concentration≥1%, such as ≥3%.

In further embodiments, the method may further comprise controlling the potential difference and/or the current flow in dependence of one or more of H₂ demand and charging level of the electrolytic cell. Hence, the electrolytic cell may be charging during no (or low) H₂ demand and discharged during (high) H₂ demand. Similarly, the electrolytic cell may be charged if the charging level≤100%, such as ≤95%, especially ≤90%, such as ≤80%, i.e., the charging may be ceased if the charging level≥80%, especially ≥90%, such as ≥95%, especially ≥99%, including 100%. In embodiments, continuing to charge the electrolytic cell while the electrolytic cell is at a high charging level may result in undesired H₂ evolution at the electron storage electrode.

In embodiments, the method may further comprise controlling the volume of an electrolyte in the cell compartment. In particular, the method may comprise reducing the volume of the electrolyte after charging to reduce self-discharge at the electron storage electrode, and the method may comprise increasing the volume of the electrolyte prior to charging and/or discharging.

In further embodiments, the method may further comprise reducing the volume of the electrolyte in the cell compartment, especially removing (substantially all of) the electrolyte from the cell compartment, and (later) adding a second electrolyte, especially wherein the second electrolyte is different from the first electrolyte.

In further specific embodiments, the method may comprise charging the electrolytic cell in the presence of a (first) electrolyte, especially a (first) electrolyte comprising sulfur, and discharging the electrolytic cell in the presence of a second electrolyte, especially (substantially) devoid of sulfur. Sulfur may enhance the charge transfer rate at the electron storage electrode during charging, which may result in more efficient and less energy-requiring charging. However, if sulfur is present in the electrolyte during discharging, H₂S could be formed, which may be undesirable for downstream processing. It will be clear to the person skilled in the art that other electrolyte(s) or electrolyte component(s) may similarly be beneficial during either charging or discharging and could be applied advantageously as described herein.

In further embodiments, the method may comprise reducing the volume of the electrolyte and adding a (similar) volume of inert gas. The concept also includes that the electrolyte in the cell may be replaced by an inert gas to reduce, especially avoid, self-discharge at the electron storage electrode during storage and transportation. This may also contribute to a safer storage method for H₂ storage. This idea also includes, that the electrolytic cell, especially the electron storage electrode, may be charged at a favorable location and then transported to another location to e.g. provide hydrogen for decentralized H₂ fueling stations. Here the electrolytic cell, especially the electron storage electrode, may be placed inside a container for easy transport or for local storage on industrial sites.

Hence, in specific embodiments, the method further comprises: (i) replacing at least 25%, such as at least 50%, especially at least 75%, of the (cell compartment) volume of electrolyte in the cell compartment with a storage gas after charging (to reduce self-discharge), and subsequently (ii) replacing at least 25%, such as at least 50%, especially at least 75%, of the (cell compartment) volume of the storage gas in the cell compartment with a second electrolyte prior to discharging (of the electrolytic cell). In further embodiments, the storage gas may comprise H₂ and/or an inert gas, especially the storage gas may comprise an inert gas. In further embodiments, the electrolyte and the second electrolyte may be different electrolytes. In further embodiments, the electrolyte and the second electrolyte may be the same electrolyte.

In further embodiments, the method may comprise replacing at least 25%, such as at least 50%, especially at least 75%, of the (cell compartment) volume of electrolyte in the cell compartment with an inert storage gas after discharging.

In embodiments wherein the electron storage electrode comprises an iron-based electrode, the method may comprise discharging the electrolytic cell according to the reactions

2H₂O+2e⁻→H₂+2OH⁻

at the cathode (here: the gas evolution electrode), and

Fe+2OH⁻→Fe(OH)₂+2e⁻

at the anode (here: the electron storage electrode).

Similarly, in such embodiments, the method may comprise charging the electrolytic cell according to the reactions:

Fe(OH)₂+2e⁻→Fe+2OH⁻

at the cathode (here: the electron storage electrode) and

4OH⁻→2H₂O+O₂+4e⁻

at the anode (here: the gas evolution electrode).

In embodiments wherein the electron storage electrode comprises a cadmium-based electrode, the method may comprise discharging the electrolytic cell according to the reaction:

Cd+2OH⁻→Cd(OH)₂+2e⁻

at the anode (with aforementioned H₂ evolution reaction at the cathode), and charging the electrolytic cell according to the reaction:

Cd(OH)₂+2e⁻→Cd+2OH⁻

at the cathode (with aforementioned O₂ evolution reaction at the anode).

In embodiments wherein the electron storage electrode comprises a zinc-based electrode, the method may comprise discharging the electrolytic cell according to the (simplified) reaction:

Zn+2OH⁻→Zn(OH)₂+2e⁻

at the anode (with aforementioned H₂ evolution reaction at the cathode), and charging the electrolytic cell according to the (simplified) reaction:

Zn(OH)₂+2e⁻→Zn+2OH⁻

at the cathode (with aforementioned O₂ evolution reaction at the anode).

In embodiments, a self-discharge reaction may occur at the electron storage electrode. Especially, the temperature of the electrolytic cell may be selected to promote H₂-release via self-discharge (the gas evolution electrode is inactive during self-discharge). Hence, in embodiments, the method may comprise self-discharging the electron storage electrode according to the reaction:

Fe+2H₂O→Fe(OH)₂+H₂

As will be clear to the person skilled in the art, Fe(OH)₂ may be the main (self-)discharge product of an iron-based electron storage electrode. However, further oxidized iron compounds such as Fe₃O₄ and FeOOH may also be present as (minor) (self-)discharge products at an iron-based electron storage electrode.”

In embodiments, the method comprises arranging the electrolytic cell in a pressure chamber (also: “pressure room”), especially in a pressure cell (also: “pressure vessel”). The pressure chamber may especially be configured to provide one or more pressures (at different times) selected from the range of 0.1-800 bar. In further embodiments, the method may comprise (controlling the pressure cell for) charging the electrolytic cell at a first pressure and discharging the electrolytic cell at a second pressure, especially wherein the first pressure is different from the second pressure. In further embodiments, the first pressure and the second pressure may also be the same pressure.

Hence, in embodiments, the method may further comprise controlling a gas pressure within the cell compartment. Phrases such as “charging the electrolytic cell at a first pressure” may especially refer to the first pressure being imposed to the cell compartment of the electrolytic cell.

In embodiments, the method may comprise discharging the electrolytic cell at a gas pressure selected from the range of 0.1-800 bar, such as from the range of 1-800 bar, especially from the range of 10-800 bar. Electrolytic cells used for storage or regeneration may be operated without pressurization, i.e., in embodiments the method may comprise charging (or storing) the electrolytic cell at a gas pressure selected from the range of 0.1-10 bar, especially at atmospheric pressure.

Hence, the method may comprise charging of the electron storage electrode together with O₂ production under atmospheric conditions while discharging the electron storage electrode with H₂ production under pressurized conditions. Producing H₂ under pressurized conditions may be beneficial as e.g., industrial processes may use H₂ at pressures above atmospheric pressure. In such embodiments, (pressurized) electrochemical production of H₂ may require a higher potential (difference), i.e., it costs more energy to produce a gas at higher pressure. Here oxygen is produced at atmospheric conditions, no extra cost. Only hydrogen is produced at high pressure, and costs extra energy. This may also save material costs; only the currently used units for H₂ production need to be in the pressure chamber.

In embodiments, the method may further comprise controlling a temperature of the cell compartment below a maximum temperature Tₘₐₓ during a charging time and/or a storage time, especially during a charging time, wherein the maximum temperature Tₘₐₓ≤40° C. The temperature of the cell compartment may relate to the H₂ evolution at the electron storage electrode, especially higher temperatures may lead to more undesired H₂ evolution at the electron storage electrode. Hence, temperature control may be an option during charge and/or storage to suppress H₂ evolution.

In embodiments the electrolytic system may comprise the electrolytic cell according to the invention and a control system configured to carry out the method according the invention.

In a further aspect, the invention further provides a use of the electrolytic system, especially the electrolytic cell, according to the invention, wherein the cell compartment comprises an electrolyte in fluid contact with the gas evolution electrode and the electron storage electrode, wherein during at least part of a charging time the electrolytic cell is charged at a potential difference between the gas evolution electrode and the electron storage electrode of more than 1.2 V, especially a potential difference≥1.37 V, and wherein during at least part of a discharging time the electrolytic cell is discharged at a potential difference between the electron storage electrode and the gas evolution electrode selected from the range of 0.0-1.0 V, i.e., wherein during at least part of a charging time the electrolytic cell is charged at a potential difference between the gas evolution electrode and the electron storage electrode of more than 1.2 V, especially a potential difference≥1.37 V, and wherein during at least part of a discharging time the electrolytic cell is discharged at a potential difference between the gas evolution electrode and the electron storage electrode selected from the range of 0.0-−1.0 V.

The embodiments described herein are not limited to a single aspect of the invention. For example, an embodiment describing the electrolytic cell with respect to its functionalities further relates, for example, to the method for controlling the electrolytic cell. Similarly, an embodiment of the method describing a operation of the electrolytic cell may indicate that the electrolytic cell may, in embodiments, be suitable for the operation. For example, if the method describes controlling the temperature of the electrolytic cell during operation, it may be clear that the electrolytic cell may comprise or be functionally coupled to a thermal management system (during operation).

The electrolytic cell may be part of or may be applied in an electrolysis system, a fuel cell system, a hydrogen production system, a hydrogen storage system, a(n industrial) production system, a hydrogen gas station, a hydrogen tank station.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-B schematically depict embodiments of the electrolytic cell.

FIG. 2A-C schematically depict an embodiment of the electrolytic cell.

FIG. 3A-B schematically depicts further embodiments of the electrolytic cell.

FIG. 4 schematically depicts an embodiment of the method.

The schematic drawings are not necessarily on scale.

### DETAILED DESCRIPTION OF THE EMBODIMENTS

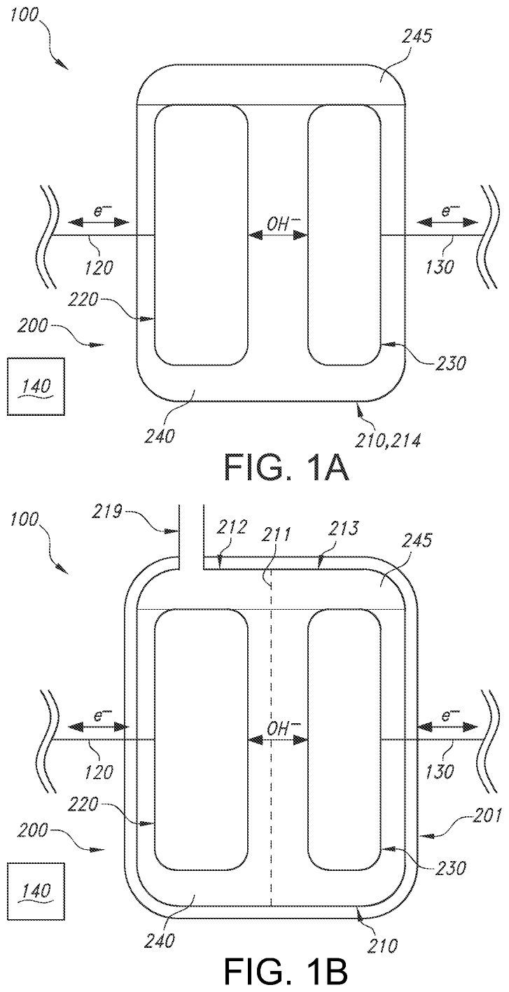

FIG. 1A schematically depicts an embodiment of the electrolytic cell 200 for temporally shifted electrolytic production of H₂ and O₂. The electrolytic cell 200 comprises a cell compartment 210, wherein the cell compartment 210 comprises a gas evolution electrode 220 and an electron storage electrode 230. In the depicted embodiment, the gas evolution electrode 220 comprises a nickel-based electrode, and the electron storage electrode 230 comprises an iron-based electrode. In embodiments, an electrochemical storage capacity C_{gee} of the gas evolution electrode 220 may be≤1% of an electrochemical storage capacity Cₑₛₑ of the electron storage electrode 230.

In the depicted embodiment, an electrolytic system 100 comprises the electrolytic cell 200 and a control system 140 configured to control the electrolytic system 100. The electrolytic system 100, especially the electrolytic cell 200, comprises a first electrical connection 120 functionally coupled to the gas evolution electrode 220, and a second electrical connection 130 functionally coupled to the electron storage electrode 230. In further embodiments, the control system 140 is configured to carry out the method 300 according to the invention.

In embodiments, the electrochemical storage capacity C_{gee} of the gas evolution electrode 220 may be≤5%, such as ≤1%, especially ≤0.1%, of the electrochemical storage capacity Cₑₛₑ of the electron storage electrode 230. In further embodiments, a (total) surface area of the gas evolution electrode 220≥50% of a (total) surface area of the electron storage electrode 230, especially the geometric surface area of the side of the gas evolution electrode facing the electron storage electrode≥50% of the geometric surface area of the side of the electron storage electrode facing the gas evolution electrode. In the depicted embodiment wherein the volume of the electrodes appears roughly equal, the gas evolution electrode 220 may comprise a (Ni-)mesh electrode. In further embodiments, the bulk volume of the gas evolution electrode 220 may be smaller (or larger) than the electron storage electrode.

In the depicted embodiment, the cell compartment 210 is a membrane-free compartment 214.

FIG. 1B schematically depicts a further embodiment of the electrolytic cell 200. In the depicted embodiment, the cell compartment 210 comprises the gas evolution electrode 220, the electron storage electrode 230, the electrolyte 240, a gas 245, and a membrane 211. The gas 245 may, in embodiments, be one or more of be a charging gas comprising O₂, a discharging gas comprising H₂, or an inert gas, such as N₂.

In embodiments, the electrolytic cell 200 may comprise an airtight housing 201 comprising the cell compartment 210, wherein the airtight housing 201 is substantially closed. In further embodiments, the cell compartment 210 may comprise a cell compartment opening 219 configured for adding a fluid, such as electrolyte 240, to the cell compartment 210 and/or for removing a fluid, such as the gas 245, from the cell compartment 210. In further embodiments, the cell compartment 210 may comprise two or more cell compartment openings 219. A cell compartment 210 comprising two or more cell compartment openings 219 may be beneficial for, for example, purging of the cell compartment with a gas, such as inert gas, especially N₂. Hence, the airtight housing 201 may be substantially closed, except for the cell compartment opening(s) 219.

The membrane 211 may be arranged between the gas evolution electrode 220 and the electron storage electrode 230. The membrane may be configured to block transport of one or more of O₂ and H₂ between the gas evolution subcompartment 212 and the electron storage subcompartment 213, especially H₂. The membrane may further be configured to allow transport of one or more of H₂O and OH⁻ between the gas evolution subcompartment 212 and the electron storage subcompartment 213. Hence, the membrane may be impermeable to one or more of O₂ and H₂, and the membrane may be permeable to one or more of H₂O and OH⁻.

In further embodiments, the gas evolution subcompartment 212 and the electron storage subcompartment 213 may each comprise or be functionally coupled to a respective cell compartment opening 219.

In the depicted embodiment, the membrane 211 separates the cell compartment 210 in two subcompartments, i.e., the membrane 211 defines a gas evolution subcompartment 212 (comprising the gas evolution electrode) and an electron storage subcompartment 213 (comprising the electron storage electrode).

In further embodiments, the membrane 211 may be arranged along part of a dimension of the cell compartment 210. For example, the membrane may be arranged to separate (or: facilitate separating) the electrolyte 240 in two regions, or the membrane may be arranged to separate (or: facilitate separating) the gas 245 in two regions. It will be clear to the person skilled in the art that, in such embodiments, the separation of the membrane 211 will depend on the respective amounts of electrolyte 240 and gas 245 in the cell compartment 210.

In embodiments, the electrolytic cell 200 may comprise an electrolyte 240 during use, especially during (dis-)charging, of the electrolytic cell. If the electrolytic cell 200 is not being actively charged or discharged, the electrolytic cell 200 may be devoid of electrolyte 240, i.e., in embodiments, the electrolytic cell 200 may be devoid of electrolyte 240. In the depicted embodiment, the electrolytic cell 200 comprises an electrolyte 240 at an electrolyte level approximately equal to the top of the electrodes, i.e., in the depicted embodiment the electrolyte 240 may essentially surround the electrodes. In embodiments, the electrolyte level may be varied during operation.

The electrolytic cell 200 is schematically depicted in operation in FIG. 1A-B.

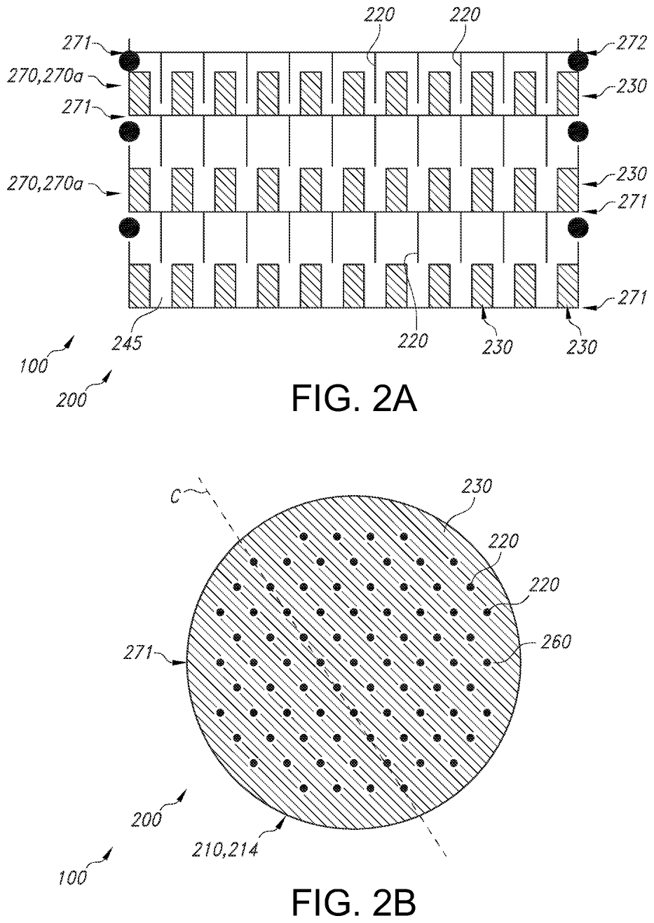

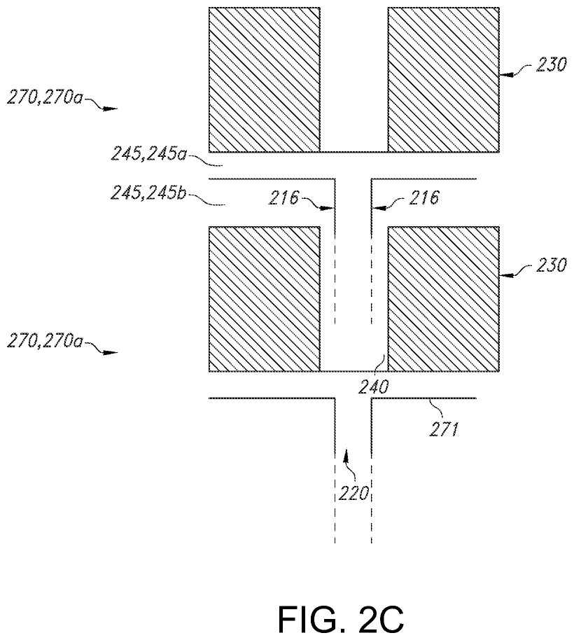

FIG. 2A schematically depicts a cross-sectional side view of an embodiment of the electrolytic cell 200. Especially, an embodiment of the electrolytic cell 200 comprises a bipolar arrangement (of electrodes) 270, especially a horizontal bipolar arrangement (of electrodes) 270, 270a. The electrolytic cell 200 comprises a bipolar plate 271, especially a bipolar plate comprising a vat (also “container”). The electrolytic cell comprises an electron storage electrode 230 arranged on a first side, especially a top side, of the bipolar plate 271. The electrolytic cell comprises a gas evolution electrode 220 arranged on a second side (especially a bottom side) of the bipolar plate 271. Two bipolar plates 271 may be stacked on each other to provide an interdigitation of the gas evolution electrode 220 and the electron storage electrode 230. In the depicted embodiment, four stacked bipolar plates 271 are drawn (no electron storage electrode 230 drawn on the top bipolar plate 271, no gas evolution electrode 220 drawn below the bottom bipolar plate 271). For visualization purposes only, the top two bipolar plates 271 are drawn in close proximity (interdigitated), whereas the middle two and bottom two bipolar plates 271 are drawn further apart. During operation, the (electrodes of the) bipolar plates 271 may be preferably interdigitated (such as the depicted top two bipolar plates 271). Two stacked bipolar plates 271 may be connected via a plate sealing 272.

In embodiments, in a stack of bipolar plates 271, the bottom bipolar plate and the top bipolar plate may comprise or be functionally coupled with an electrical connection, especially a first electrical connection 120 functionally coupled to the gas evolution electrode 220, and a second electrical connection 130 functionally coupled to the electron storage electrode 230.

In embodiments, the bipolar plate 271 may comprise a top opening and/or a bottom opening, especially wherein the top opening is configured for adding and/or removing a gas 245, and wherein the bottom opening is configured for adding and/or removing electrolyte 240. In the depicted embodiment, the electrolytic cell 200 is devoid of electrolyte 240 (which may be added prior to charging and/or discharging of the electrolytic cell 200).

FIG. 2B schematically depicts a top view of the embodiment of FIG. 2A. Reference sign C indicates a possible location of the cross-sectional view depicted in FIG. 2A. Hence, in embodiments, the electron storage electrode 230 may comprise a single continuous electrode, whereas the gas evolution electrode 220 comprises a plurality of spatially separated gas evolution electrodes 220 in functional contact with different parts of the electron storage electrode 230. In the depicted embodiment, each of the gas evolution electrodes 220 is surrounded by a separation space 260 configured to prevent short-circuiting between the gas evolution electrodes 220 and the electron storage electrode 230. Hence, in embodiments, the volume of the electrolytic cell 200 may essentially comprise electron storage electrode except for the space for gas evolution electrodes 220 and corresponding space 260.

In further embodiments, (each of) the gas evolution electrode(s) 220 may have an (approximately) cylindrical shape and the electron storage electrode 230 may comprise (approximately) a cylindrical hole to host the gas evolution electrode 220 (and the electrolyte 240) and to provide the separation space 260. In such embodiments, the outer (cylindrical) (non-base) surface area of the gas evolution electrode 220 may be≥10% of the inner (cylindrical) surface area of the (cylindrical hole of the) electron storage electrode (230), especially ≥20%, such as ≥35%, especially ≥50% such as ≥75%, especially ≥90%, including 100%. Similarly, in further embodiments, the inner (cylindrical) (non-base) surface area of the gas evolution electrode may be≤125%, especially ≤100%, such as ≤90%, especially ≤80%.

FIG. 2C schematically depicts a close-up of the embodiment depicted in FIG. 2A. In the depicted embodiment, the electrolyte 240 may be configured between the electron storage electrode 230 and the gas evolution electrode 220 (essentially in the separation space 260). The gas evolution electrode 220 may comprise a hollow electrode. The gas evolution electrode 220 may be surrounded by a separator 216 configured to block transport of one or more of O₂ and H₂. The gas evolution electrode 220 may comprise a hydrophobic coating, especially a hydrophobic coating configured to guide a gas 245 evolved at the gas evolution electrode. Hence, in embodiments, a hydrophobic coating may be applied to the inside of the (hollow) gas evolution electrode 220. In further embodiments, the gas evolution electrode 220 may comprise a porous electrode comprising a hydrophobic coating, especially the gas evolution electrode 220 may comprise a porous electrode internally comprising a hydrophobic coating, i.e., a hydrophobic coating arranged at the inside of the porous electrode.

In embodiments, the bipolar plate 271 may comprise or be functionally coupled to an isolator configured to separate the bipolar plate 271 from the electrolyte 240, i.e. configured to reduce, especially prevent, direct contact between the bipolar plate 271 and the electrolyte 240. In further embodiments, the electrolytic cell 200 may comprise an isolator arranged between the bipolar plate 271 and the electrolyte 240. In further embodiments, the isolator may comprise a plastic cover.

Hence, during charging, the gas evolution electrode 220 may provide a first gas 245a that can leave the electrolytic cell 100 through a first headspace, especially through a hollow section in the bipolar plate 271, especially a hollow section comprising a hydrophobic coating, and the electron storage electrode 230 may provide a second gas 245b (essentially the self-discharge gas) that becomes trapped in a second headspace arranged between one or more of separators 216, bipolar plate 271, electrolyte 240, and electron storage electrode 230.

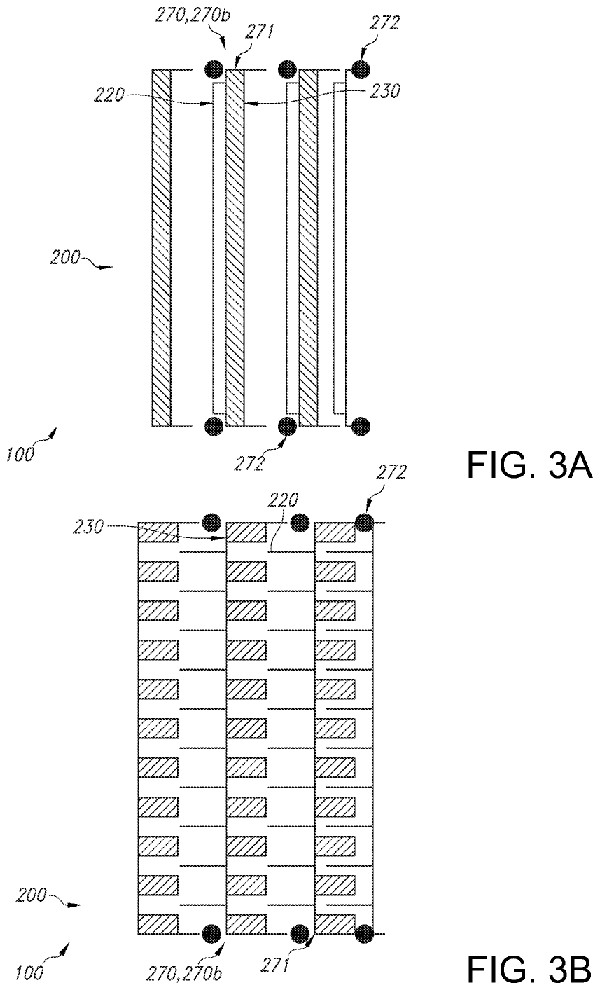

FIG. 3A-B schematically depict top views of an embodiment of the electrolytic cell 200 comprising a vertical bipolar arrangement (of electrodes) 270, 270b. For visualization purposes only the two rightmost bipolar plates 271 are drawn in close proximity, whereas the middle two and the two leftmost bipolar plates 271 are drawn spaced apart for visualization purposes.

In embodiments wherein the electrolytic cell 200 comprises the vertical bipolar arrangement 270, 270b, the gas evolution electrode 220 and the electron storage electrode 230 may especially comprise flat and/or sheet-like electrodes. The embodiment comprising interdigitation of the gas evolution electrode 220 and the electron storage electrode 230 as depicted in FIG. 3B may provide a higher storage density and/or reduced gas evolution electrode volume (including separation space 260) relative to the embodiment as depicted in FIG. 3A.

In embodiments, the horizontal bipolar arrangement 270, 270a and/or the vertical bipolar arrangement 270, 270b may provide scalability as arrangement with a plurality of bipolar plates 271 can be provided.

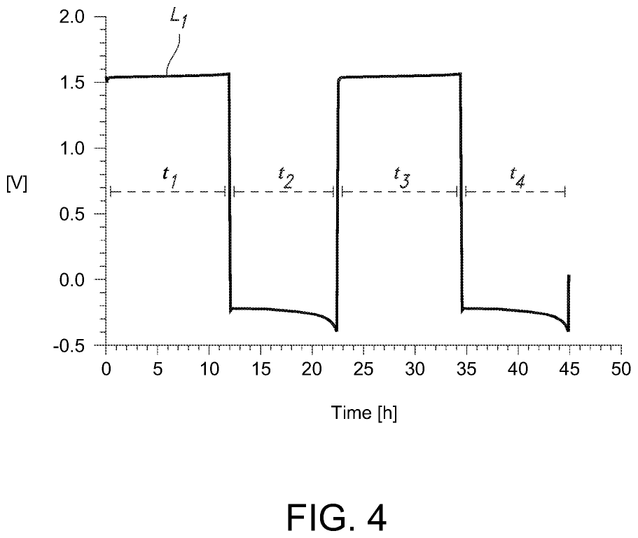

FIG. 4 schematically depicts experimental observations obtained using the method 300 for controlling the electrolytic cell 200. The method comprises controlling the potential difference and/or the current flow, in the depicted embodiment especially controlling the current flow, between the gas evolution electrode 220 and the electron storage electrode 230. Line L₁ indicates the measured voltage between the gas evolution electrode 220 and the electron storage electrode 230 (V_{gee}−Vₑₛₑ) while charging/discharging with a controlled current flow. In this tested embodiment, the gas evolution electrode 220 comprises a SST mesh and the electron storage electrode 230 comprises an iron-based electrode. During a first time period τ₁ and a third time period τ₃, a current flow was imposed between the gas evolution electrode 220 and the electron storage electrode 230 for charging of the electrolytic cell 200, resulting in O₂ evolution at the gas evolution electrode 220, a Fe(OH)₂→Fe transition at the electron storage electrode 230, and some H₂ evolution at the electron storage electrode 230 (due to self-discharge). During a second time period τ₂ and a fourth time period τ₄ a current flow was imposed between the gas evolution electrode 220 and the electron storage electrode 230 for discharging of the electrolytic cell 200, resulting in H₂ evolution at the gas evolution electrode 220 and a Fe→Fe(OH)₂ transition at the electron storage electrode 230. During the first time period τ₁ and the third time period τ₃ O₂ and H₂ were produced in a ratio of approximately 7.5:1. During the second time period τ₂ and the fourth time period τ₄ approximately no O₂ was produced. The ratio of H₂ produced in τ₁ and τ₃ versus τ₂ and τ₄ was approximately 6.5:1.

In embodiments, the method 300 may further comprise controlling the potential difference and/or the current flow in dependence of one or more of H₂ demand and charging level of the electrolytic cell 200.

In embodiments, the method may further comprise controlling the volume of an electrolyte 240 in the cell compartment 210. For example, with respect to the embodiment of the electrolytic cell 200 depicted in FIG. 1B, the method may comprise controlling the volume (or “level”) of the electrolyte 240 and gas 245 in the cell compartment 210. In further embodiments, the method 300 may comprise replacing at least 50% of the cell compartment volume of electrolyte 240 in the cell compartment 210 with an inert gas after charging and subsequently replacing at least 50% of the cell compartment volume of the inert gas in the cell compartment 210 with a second electrolyte prior to discharging. In further embodiments, the electrolyte 240 and the second electrolyte may be different, especially the electrolyte 240 and the second electrolyte may be the same.

FIG. 4 also schematically depicts a use of the electrolytic system 100, especially the electrolytic cell 200, according to the invention. During the use, the cell compartment 210 comprises an electrolyte 240 in fluid contact with the gas evolution electrode 220 and the electron storage electrode 230. During at least part of a charging time the electrolytic cell 200 is charged at a potential difference between the gas evolution electrode 220 and the electron storage electrode 230 of more than 1.2 V, especially a potential difference≥1.37 V, such as ≥1.6 V, especially ≥1.8 V (here: 1.6 V). During at least part of a discharging time the electrolytic cell 200 is discharged at a potential difference between the electron storage electrode 230 and the gas evolution electrode 220 selected from the range of 0.0-1.0 V (here: 0.25V). In embodiments, the cell compartment 210 may comprise an electrolyte 240 during the charging time and may comprise a second electrolyte during the discharging time, wherein the electrolyte and the second electrolyte are different.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”.

For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The term “further embodiment” may refer to an embodiment comprising the features of the previously discussed embodiment, but may also refer to an alternative embodiment.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. An electrolytic cell (200) for temporally shifted electrolytic production of H₂ and O₂, the electrolytic cell (200) comprising a cell compartment (210), wherein the cell compartment (210) comprises a gas evolution electrode (220) and an electron storage electrode (230), wherein the gas evolution electrode (220) comprises an electrode selected from the group consisting of a nickel-based electrode, a stainless steel-based electrode, a titanium-based electrode and a platinum-based electrode, wherein the electron storage electrode (230) comprises an iron-based electrode, and wherein an electrochemical storage capacity C_{gee} of the gas evolution electrode (220) is≤5% of an electrochemical storage capacity Cₑₛₑ of the electron storage electrode (230).

2. The electrolytic cell (200) according to claim 1, wherein a surface area of the gas evolution electrode (220)≥10% of a surface area of the electron storage electrode (230), and wherein the surface area of the gas evolution electrode is≤125% of the surface area of the electron storage electrode, and wherein the electrochemical storage capacity C_{gee} of the gas evolution electrode (220) is≤0.1% of the electrochemical storage capacity Cₑₛₑ of the electron storage electrode (230), and wherein the gas evolution electrode (220) comprises an electrode selected from the group comprising a porous electrode, a mesh electrode, a wire electrode, and a plate electrode.

3. The electrolytic cell (200) according to claim 1, wherein the cell compartment (210) comprises a cell compartment opening (219) configured for adding a fluid to the cell compartment (210) and/or for removing a fluid from the cell compartment (210) and wherein the electrolytic cell (200) comprises an airtight housing (201) comprising the cell compartment (210).

4. The electrolytic cell (200) according to claim 1, wherein the cell compartment (210) further comprises a separator (216) arranged between the gas evolution electrode (220) and the electron storage electrode (230), wherein the separator (216) defines a gas evolution subcompartment (212) and an electron storage subcompartment (213), wherein the separator (216) is configured to block transport of one or more of O₂ and H₂ between the gas evolution subcompartment (212) and the electron storage subcompartment (213).

5. The electrolytic cell (200) according to claim 4, wherein the separator (216) is a membrane (211).

6. The electrolytic cell (200) according to claim 1, wherein the cell compartment (210) is a membrane-free compartment (214).

7. The electrolytic cell (200) according to claim 1, wherein the electrolytic cell (200) comprises a recombination catalyst configured to catalyze a recombination of H₂ and O₂ to H₂O, and/or wherein the electron storage electrode (230) comprises an additive selected from the group comprising bismuth sulfide, bismuth oxide, Sn, and Pb.

8. The electrolytic cell (200) according to claim 1, wherein the cell compartment (210) comprises an electrolyte (240), wherein the electrolyte is a liquid electrolyte, wherein the concentration of hydroxide (OH⁻) in water is selected from the range of 0.1-8 mol/L.

9. The electrolytic cell (200) according to claim 1, wherein the electrolytic cell (200) comprises a vertical bipolar arrangement (270, 270b) or a horizontal bipolar arrangement (270, 270a).

10. The electrolytic cell (200) according to claim 1, wherein the electrolytic cell (200) comprises or is functionally coupled to a charge control unit, wherein during a charging operation, the charge control unit is configured to impose a potential difference between the gas evolution electrode (220) and the electron storage electrode (230)≥1.37 V, and during a discharging operation, the charge control unit is configured to impose a potential difference between the electron storage electrode (230) and the gas evolution electrode (220) selected from the range of 0.01-1.0 V.

11. The electrolytic cell (200) according to claim 1, wherein the electron storage electrode is a solid electrode.

12. The electrolytic cell (200) according to claim 1, wherein during operation, the iron-based electron storage electrode goes through Fe→Fe(OH)₂→Fe cycles.

13. A method (300) for controlling the electrolytic cell (200) according to claim 1, the method comprising controlling a potential difference and/or a current flow between the gas evolution electrode (220) and the electron storage electrode (230).

14. The method (300) according to claim 13, wherein the method (300) further comprises controlling the potential difference and/or the current flow in dependence of one or more of H₂ demand and charging level of the electrolytic cell (200).

15. The method (300) according to claim 13, wherein the method (300) further comprises controlling the volume of an electrolyte (240) in the cell compartment (210), wherein the method (300) further comprises: (i) replacing at least 50% of the cell compartment volume of electrolyte (240) in the cell compartment (210) with a storage gas after charging, and subsequently (ii) replacing at least 50% of the cell compartment volume of the storage gas in the cell compartment (210) with a second electrolyte prior to discharging, wherein the storage gas comprises H₂ and/or an inert gas.

16. The method (300) according to claim 13, the method (300) further comprising controlling a temperature of the cell compartment (210) below a maximum temperature Tₘₐₓ during a charging time, wherein the maximum temperature Tₘₐₓ≤40° C., and the method (300) further comprising controlling a gas pressure within the cell compartment (210), wherein the method comprises charging the electrolytic cell (200) at a gas pressure selected from the range of 0.1-10 bar, and wherein the method (300) comprises discharging the electrolytic cell (200) at a gas pressure selected from the range of 1-800 bar.

17. The method (300) according to claim 13, wherein the method comprises discharging the electrolytic cell according to the reactions:
2H₂O+2e⁻→H₂+2O⁻
at the gas evolution electrode, and
Fe+2OH⁻→Fe(OH)₂+2e⁻
at the electron storage electrode; and wherein the method comprises charging the electrolytic cell according to the reactions:
Fe(OH)₂+2e⁻→Fe+2OH⁻
at the electron storage electrode and
4OH⁻→2H₂O+O₂+4e⁻
at the gas evolution electrode.

18. An electrolytic system (100) comprising the electrolytic cell (200) according to claim 1, and a control system (140) configured to control the electrolytic system (100).

19. The electrolytic system (100) according to claim 17, wherein the electrolytic system (100) comprises a plurality of electrolytic cells (200), and wherein the electrolytic system (100) comprises a parallel arrangement and/or a serial arrangement of the plurality of electrolytic cells (200).

20. The electrolytic system (100) according to claim 18, wherein the control system is configured to control a potential difference and/or a current flow between the gas evolution electrode (220) and the electron storage electrode.

21. A use of the electrolytic cell (200) according to claim 1, wherein the cell compartment (210) comprises an electrolyte (240) in fluid contact with the gas evolution electrode (220) and the electron storage electrode (230), wherein during at least part of a charging time the electrolytic cell (200) is charged at a potential difference between the gas evolution electrode (220) and the electron storage electrode (230) of more than 1.2 V, and wherein during at least part of a discharging time the electrolytic cell (200) is discharged at a potential difference between the electron storage electrode (230) and the gas evolution electrode (220) selected from the range of 0.0-1.0 V.
